(19) United States
(12) Patent Application Publication
(10) Pub. No.: US 2022/0357452 A1
(43) Pub. Date: Nov. 10, 2022

(54) IMAGING SYSTEM AND DETECTION METHOD

(71) Applicant: ams International AG, JONA (CH)

(72) Inventor: Jens HOFRICHTER, JONA (CH)

(21) Appl. No.: 17/621,658

(22) PCT Filed: May 19, 2020
(86) PCT No.: PCT/EP2020/063942

§ 371 Date: Dec. 21, 2021

(30) Foreign Application Priority Data
Jun. 27, 2019 (EP) 19182961.3

(51) Int. Cl. G01S 17/89; G01S 17/10; G01S 7/481; G01S 7/499; G01S 7/4865

(52) U.S. Cl. CPC G01S 17/89; G01S 17/10; G01S 7/4816; G01S 7/499; G01S 7/4865

(57) ABSTRACT

An imaging system comprises a light emitter, a detector array and a synchronization circuit. The light emitter is arranged to emit light of modulated intensity, wherein the intensity is modulated monotonously during the acquisition of a frame. The synchronization circuit is arranged to synchronize the acquisition with the light emitter.

### CROSS-REFERENCE TO RELATED APPLICATIONS

The present application is the national stage entry of International Patent Application No. PCT/EP2020/063942, filed on May 19, 2020, and published as WO 2020/259928 A1 on Dec. 30, 2020, which claims the benefit of priority of European Patent Application No. 19182961.3, filed on Jun. 27, 2019, all of which are incorporated by reference herein in their entirety.

### FIELD OF THE DISCLOSURE

The invention relates to the field of light detection and ranging, LIDAR, systems. Moreover, it relates to imaging systems. More specifically, it relates to imaging systems with integrated LIDAR capability for distance measurements. Particularly, it relates to high-resolution imagers with distance measurement capabilities.

### BACKGROUND OF THE DISCLOSURE

Prior art deals with optical ranging system mainly through the so-called time-of-flight, TOF, approach, where an optical pulse is emitted and the time it travels is calculated with a time-to-digital converter, TDC.

Current state-of-the-art LIDAR systems can be divided into three categories:

(1) Scanning LIDAR systems with movable parts and sequential scanning of the surface. Such systems to date are for example employed for autonomous driving.

(2) LIDAR systems with solid-state lighting systems, where a number of dots are projected onto a surface. Such systems may be made small and compact; are in principle suitable for miniaturization and are for example employed in mobile devices.

(3) LIDAR systems, where a CMOS imager is used in conjunction with a receiving modulator. Such a system so far is limited to handheld devices and cannot be miniaturized, as discrete optical components are required.

FIG. 7 and FIG. 8 both show the working principle of prior art approaches (1) and (2) discussed above. FIG. 1 shows a LIDAR system wherein a light source (e.g., a laser) is emitting light pulses towards an object where the light pulse is reflected. FIG. 8 shows the LIDAR system wherein the backward travelling light pulse is detected by an appropriate photodetector. The time difference between the light pulse emission and the receiving light pulse is measured with a time-to-digital converter, TDC.

In both cases, a light pulse is emitted by light source (typically a laser) and deflected onto several objects, where it is reflected. The backward travelling light pulse is then collected by an appropriate photodetector, e.g., an avalanche photodetector or SPAD. The time difference between the light pulse emission and the received light pulse is measured or counted by a time-to-digital converter, TDC. In such a system, typically one single laser beam or a so-called point-cloud is emitted into the scenery. Therefore, the resolution is limited to a single or a few hundred pixels only.

In the third approach (3), also light pulses are usually not emitted by neither a single nor a multitude of collimated laser beams. Rather, a light source or laser beam with a certain field-of-view, FOV, in the order of several degrees is used to illuminate the scene rather uniformly. After reflection, the light pulse is collected with a CMOS imaging sensor or sensor array. The image sensor itself is configured such that is has a modulator built on top of it to modulate the intensity or phase of the incoming signal. First, an unmodulated image Idc is recorded. Then, the modulated image Imod is acquired. The modulation is made such that at the beginning of the frame the modulator is attenuating the signal. At the end of the frame the modulator allows for full transparency and the signal is not attenuated anymore.

Now, after the acquisition of both frames, the distance image is computed as a function of the modulated and the unmodulated image. Although this system works with CMOS imaging sensors in excess of 1 Mpixel, the integration of the optical path comprising polarization beam splitters and complex modulators remains a challenge.

U.S. Pat. No. 8,471,895 relates to systems and methods of high resolution three-dimensional imaging. This reference discloses a LIDAR system based on approach (3) as described above. The modulator is integrated on top of the detector. The modulator is made from an electro-optical Pockels cell, which is made from crystal materials, such as lithium niobate, for instance. Whereas such a system is known to work, it is very costly due to the price of the modulator material. Moreover, the integration with a CMOS imaging sensor is challenging.

U.S. Ser. No. 10/218,962 relates to systems and methods of high resolution three-dimensional imaging. This reference describes a similar LIDAR system as the first reference above with the difference that two sensor arrays are employed rather than one sensor array with sequential frames. Moreover, the light source may have a diffusor or any other means attached to it to reduce its coherence and thus speckle.

US 2017/0248796 A1 relates to a 3D imaging system. This reference shows use of orthogonal polarization states on top of adjacent pixels to reduce glint and suppress other unwanted effects. Again, modulation principles at the receiver side are employed. A polarization beam splitter is required in the optical path making the system large and bulky.

It is an objective to provide an imaging system and detection method, which allow for easier integration.

These objectives are achieved by the subject matter of the independent claims. Further developments and embodiments are described in dependent claims.

### SUMMARY OF THE DISCLOSURE

It is to be understood that any feature described in relation to any one embodiment may be used alone, or in combination with other features described herein, and may also be used in combination with one or more features of any other of the embodiments, or any combination of any other of the embodiments unless described as an alternative. Furthermore, equivalents and modifications not described below may also be employed without departing from the scope of the imaging system and detection method which are defined in the accompanying claims.

The following relates to an improved concept in the field of light detection and ranging, LIDAR, systems. One aspect lies in the modulation of a light source rather than modulation of a receiver. Moreover, an optical beam path is simplified thus enabling integration of a polarization beam splitter, PBS, into a CMOS imaging sensor, for example.

In at least one embodiment, an imaging system comprises a light emitter which is arranged to emit light of modulated intensity. The intensity is modulated monotonously during the acquisition of a frame. Furthermore, the imaging system comprises a detector array and a synchronization circuit to synchronize the acquisition with the light emitter.

The light emitter comprises a light source such as a light emitting diode or semiconductor laser diode, for example. One type of a semiconductor laser diode includes surface emitting lasers, such as the vertical-cavity surface-emitting laser, or VCSEL, or edge emitter lasers. VCSELs combine properties such as surface emission, which offers design flexibility in addressable arrays, low threshold current, improved reliability and the possibility to use a wafer-level manufacturing process. Another option for the light emitter is the used of light emitting diodes (LEDs). LEDs are also surface-emitting devices, but with the limitation that the radiation is non-coherent and has typically Lambertian emission characteristics as opposed to a directed laser beam. For example, the light emitter comprises, or is connected to, a modulating circuit which is arranged to modulate the intensity of the light emitter. An example of a modulating circuit is a laser driver circuit.

Typically, the light source, or light emitter, has one or more characteristic emission wavelengths. For example, an emission wavelength of the light emitter lies in the near infrared, NIR. Other wavelengths may include visible or ultraviolet, infrared (IR) or far-infrared (FIR), for example. In one embodiment the wavelength of the light emitter might be at visible wavelengths. In another embodiment the light emission might be in the infrared wavelength range, which is invisible to the human eye. In a preferred embodiment, the emission wavelength can be 850 nm or 940 nm. A narrow wavelength bandwidth (especially over temperature) allows for more effective filtering at the receiver end, e.g. at the detector array, resulting in improved signal to noise ratio (SNR). This is supported by VCSEL lasers, for example. This type of laser allows for emitting a vertical cylindrical beam, which renders the integration into the imaging system more straightforward. The emission of the laser can be made homogenous using one or a multitude of diffusers to illuminate the scene uniformly.

The detector array comprises one or more photodetectors, denoted pixels hereinafter. Typically, the pixels are implemented as solid-state or semiconductor photodetectors which are arranged or integrated into an array. Examples include CCD or CMOS imaging sensors, an array of single-photon avalanche diodes, SPADs, or other type of avalanche diodes, APDs. These types of photodetectors are sensitive to light, such as NIR, VIS, and UV, which facilitates using narrow pulse widths in emission by means of the light emitter.

The synchronization circuit is arranged to synchronize emission of light by means of the light emitter on one side and detection of light by means of the detector array in the other side. The synchronization circuit may control a delay between emission of the pulses and a time frame for detection. For example, a delay between an end of a pulse and a beginning of detection may be set, e.g., depending on a distance or distance range to be detected. The time it takes to finish a distance measurement cycle depends on the distance between the imaging system and an external target.

The detector array is arranged to acquire one or more consecutive images, denoted frames hereinafter. In order to acquire a frame the detector array may integrate incident light, using the pixels of the array, for the duration of an exposure time. Acquisition of consecutive frames may proceed with a frame rate, expressed in frames per second, for example. In this context, the term “modulation” relates to a defined change of light intensity during the acquisition of a frame as the reference. In other words, the light emitter, rather than the detector, is modulated and emits light with modulated intensity. This modulation is monotonous in a mathematical sense, i.e., the change of light intensity can be described by means of a monotonic function, e.g., a monotonic function of time. A function is called monotonic if and only if it is either entirely non-increasing, or entirely non-decreasing. In general, modulation may be monotonously increasing or decreasing. The duration of a single frame sets the time during which the intensity is modulated. Modulation may also relate to a single pulse as the reference, respectively.

During operation the light emitter emits light, e.g., towards an external target. The emitted light eventually hits the external target, gets reflected or scattered at the target, and returns to the imaging system where the detector array eventually detects the returning light. Light emitted towards a closer target in the scene may have a different stage of modulation when hitting the closer target than light irradiating a target farther away in the scene. Thus, the distance is encoded in the signals generated by the pixels, or by the image created from the array. The distance to the point of reflection or scattering can be calculated from the image, e.g., by relative intensities on a per pixel basis or from the entire image.

This approach is different from the common time-of-flight concept, which relies on measuring a time between sending light and receiving light, e.g., emitting given light pulse and receiving said pulse

Most state-of-the-art systems make use of emitting a single or a multitude of optical pulses (i.e., laser beams) towards a target. This limits the amount of pixels or points that can be acquired. This is particularly true when comparing such TOF applications with modern state-of-the-art CMOS imaging sensors. Only few prior art examples leverage the pixel count of CMOS imaging sensors. Now in turn, those prior art has the issue that the receiver is complex and expensive mainly due to the optical beam path comprising a polarization beam splitter, partially two imaging sensors in parallel, as well as an either expensive lithium niobate modulator, or an unreliable polymer modulator; both constructing a Pockels cell.

The improved concept reduces the need for complex receiver architectures. Instead, the system complexity of the linear system is moved from the receiver partially to the emitter, where the modulated illumination as well as the dc illumination of the scene are generated. The improved concept enables high-resolution LIDAR systems suitable for various applications, in particular automotive and autonomous driving. The proposed technology provides an imaging system, which extends over single laser beam deflection of point clouds of several hundreds of pixels only.

In at least one embodiment, at least the detector array and the synchronization circuit are integrated into a same chip. For example, the chip comprises a common integrated circuit into which at least the detector array and synchronization circuit are integrated. Typically, the light emitter and the common integrated circuit are arranged on and electrically contacted to each other via a shared carrier or substrate. However, in other implementations the light emitter may also be integrated into the common integrated circuit. Integration allows for compact design, reducing board space requirements, enabling of low-profile system designs in restricted space designs. Additionally, the complexity of the beam path can be reduced. Implementation on a same chip, e.g., embedded in a same sensor package, allow for an imaging system, which can observe a complete field of view (FOV) at once, called Flash systems. Such imaging system may emit short pulses of light, for instance in the near infrared (NIR) wavelength region. A portion of that energy is returned and converted in distance and optionally intensity and ultimately speed, for example. By taking many samples, it is possible to filter out noise (detected light not being a reflection of the emitted pulse).

In at least one embodiment, the imaging system comprises a modulating circuit. The modulating circuit is arranged to drive emission of light by means of the light emitter. For example, the modulating circuit is arranged as a laser driver and is operable to modulate the intensity of the light emitter. Emission of light can be pulsed such that, due to modulation, at least some pulses have an intensity profile which is monotonously increasing or monotonously decreasing as a function of time, e.g. a time duration of a given pulse. The modulating circuit may also be integrated into the same integrated circuit or chip. Due to modulation, at least some pulses have an intensity profile which is monotonously increasing or monotonously decreasing as a function of time.

For example, under control of the modulating circuit, or laser driver, the light emitter emits pulses of light rather than a continuous wave. The modulating circuit may drive the light emitter to emit pulses of constant intensity, e.g., constant as a function of time. The modulating circuit may alternatively drive the light emitter to emit pulses with modulated intensity. The intensity of a given pulse either increases monotonically due to modulation. In order to increase monotonically the intensity of the pulse, considered as a function of time, does not exclusively have to increase, it simply must not decrease. However, the intensity of a given pulse may also decrease monotonically during the modulation. In order to decrease monotonically the intensity of the pulse, considered as a function of time, does not exclusively have to decrease, but must not increase.

In at least one embodiment, the synchronization circuit is operable to control a delay between emission of light and a time frame for detection. The synchronization may control a delay between emission of the pulses and a time frame for detection. For example, a delay between an end of the pulse and a beginning of detection may be set, e.g., depending on a distance or distance range to be detected.

In at least one embodiment, the detector array comprises pixels, which have a polarizing function. For example, integrated polarization-sensitive photodiodes can be used. A possible sensor is disclosed in EP 3261130 A1, which is hereby incorporated by reference.

For example, the detector array may have on-chip polarizers associated with the pixels, respectively. Such a structure may be integrated using CMOS technology. Alternatively, the polarizers can be placed on-chip using an air-gap nano-wire-grid coated with an anti-reflection material that suppresses flaring and ghosting. Such an on-chip design reduces polarization crosstalk and improves extinction ratios. Alternatively, the detector array may be complemented with a layer of polarizers arranged above the pixels, respectively. The layer of polarizers may not necessarily be integrated with the detector array. For example, the layer of polarizers comprises a number of polarizers which are arranged in the layer such that they coincide with respectively pixels when mounted on top of the detector array.

The polarizer can be implemented by an array of either horizontal or vertical lines, which may be made from metal but also from other dielectric or semiconductor materials. Adjacent photodiodes might have different orientations of the polarizers to detect different polarization states of the light. Only one metal level may be present, optionally metal 1, where the remainder of the back-end-of-line is clear. However, also polarizers comprising semiconductor materials or dielectric materials can be contemplated. Moreover, high-contrast gratings could be integrated in the CMOS process by using polysilicon or other gate materials for instance.

During operation of the imaging system, a scene may be illuminated using the light emitter. In general, the scene comprises several external targets, which each may reflect or scatter light. The reflection or scattering of light off the targets typically produces polarized light, such as linearly polarized light in the plane perpendicular to the incident light. Polarization may further be affected by material properties of the external targets, e.g., properties of their surfaces. Polarization may thus be visible in an image acquired by the detector array. For example, by illuminating the scene typically a number of external targets with different distances are acquired in the image. A given target, however, may show similar or same polarization as its properties, characteristic for their surfaces, for example, may not change considerably over the illuminated surface. In contrast, other targets at different distances may show different polarization. Thus, pixels, which have a polarizing function may further increase contrast and signal-to-noise ratio in the resulting image so that different external targets can be distinguished in the image more easily.

In at least one embodiment, adjacent pixels have orthogonal polarization functions. Using adjacent pixels with different polarization functions allows for the detection of more linear angles of polarized light, e.g., 0° and 90°, or 180° and 270°. This is possible through comparing the rise and fall in intensities transmitted between adjacent pixels, for example.

In at least one embodiment, a unit of four pixels has four different polarization functions, respectively. For example, said unit is complemented with polarizers associated with the pixels of four different angles such as 0°, 45°, 90°, and 135°. Every unit of four pixels may be combined as a calculation unit, such that four sensor signals may be collected for a given calculation unit. Sensor signals from a calculation unit are related via the different directional polarizers and allow the calculation of both the degree and direction of polarization.

In at least one embodiment, the emission wavelength of the light emitter is larger than 800 nm and smaller than 10.000 nm. In at least one embodiment the emission wavelength of the light emitter is in between 840 nm and 1610 nm. Detection in these spectral ranges is essentially infrared and results in robust emission and detection. Furthermore, light in these spectral ranges is essentially invisible and disguised from human's vision.

In at least some embodiments, the imaging system is operable to carry out a LIDAR detection method, e.g., based on the concept discussed in U.S. Pat. No. 8,471,895.

In at least one embodiment, the imaging system further comprises a processing unit, such as a microcontroller or processor. The processing unit is arranged to control the light emitter, e.g., via the modulating circuit, to emit a first, unmodulated light pulse in order to acquire a first image using the detector array. Furthermore, the light emitter is controlled, via the modulating circuit, to emit a second, modulated light pulse in order to acquire a second image using the detector array. The processing unit is further arranged to process the first and second image to calculate a LIDAR image inferred from a ratio of the second image to the first image and to determine a distance of objects in the LIDAR image.

Detection may involve this example sequence of operation.
1) Emission of a light pulse with constant irradiance,
2) Acquisition of the “constant image”, e.g., as first image during a first frame,
3) Emission of a modulated light pulse,
4) Acquisition of the “modulated image”, e.g., as second image during a second frame,
5) Calculation of the LIDAR image by division of “modulated image” by “constant image”.

In at least one embodiment, a detection method a scene is illuminated with a first and a second light pulse. The first light pulse is unmodulated in order to acquire a first image. The second light pulse is modulated light pulse in order to acquire a second image. For example, intensity is modulated monotonously during the acquisition of a frame. The method may be executed using an imaging system described above.

In at least one embodiment, the order of the images can also be inverted. I.e., first, the modulated image is acquired and then the unmodulated image is acquired.

In at least one embodiment, a distance of objects of the scene is determined depending on the first and second image.

In at least one embodiment, a LIDAR image is inferred from a ratio of the second image to the first image and distance information of the scene is determined from the LIDAR image.

A distance to one or more objects can be concurred from relative intensities in the LIDAR image. For example, as the intensity of the light source is linearly reduced, such that items being further away in the scene receive a higher intensity. Close objects receive less intensity. These differences may be apparent in the LIDAR image and provide a measure of distance. No modulation of detector is required.

In at least one embodiment, a vehicle, such as a car or other motor vehicle, comprises an imaging system according to the improved concept discussed below. A board electronics, such as Advanced Driver Assistance System, ADAS, is embedded in the vehicle. The imaging system is arranged to provide an output signal to the board electronics. Possible applications include automotive such as autonomous driving, collision prevention, security and surveillance, as well as industry and automation and consumer electronics.

Further implementations of the detection method are readily derived from the various implementations and embodiments of the imaging system and vehicle and vice versa.

In the following, the concept presented above is described in further detail with respect to drawings, in which examples of embodiments are presented. In the embodiments and Figures presented hereinafter, similar or identical elements may each be provided with the same reference numerals. The elements illustrated in the drawings and their size relationships among one another, however, should not be regarded as true to scale, rather individual elements, such as layers, components, and regions, may be exaggerated to enable better illustration or a better understanding.

### BRIEF DESCRIPTION OF THE DRAWINGS

FIG. 1 shows an example of the imaging system.

FIG. 2 shows an example embodiment of a detector array with polarization function,

FIG. 3 shows a cross section of an example detector array with a high-contrast grating polarizer,

FIG. 4 shows an example embodiment of a LIDAR detection method,

FIG. 5 shows an example embodiment of a LIDAR detection method,

FIG. 6 shows an example timing diagram of the light source,

FIG. 7 shows an example embodiment of a prior art LIDAR detection method, and

FIG. 8 shows another example embodiment of a prior art LIDAR detection method.

### DETAILED DESCRIPTION

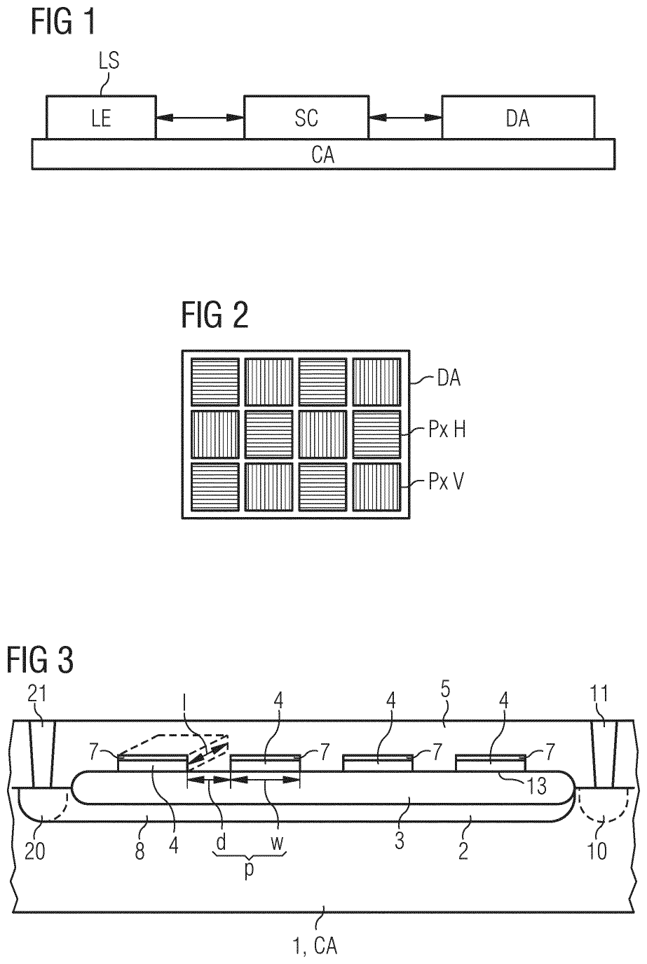

FIG. 1 shows an example imaging system. The imaging system comprises a light source LS, a detector array DA and a synchronization circuit SC, which are arranged contiguous with and electrically coupled to a carrier CA. For example, the carrier comprises a substrate to provide electrical connectivity and mechanical support. The detector array and the synchronization circuit are integrated into a same chip CH which constitutes a common integrated circuit. Typically, the light source and the common integrated circuit are arranged on and electrically contacted to each other via the carrier. The components of imaging system are embedded in a sensor package (not shown). Further components such as a processing unit, e.g., a processor or microprocessor, to execute the detection method and ADCs, etc. are also arranged in the sensor package and may be integrated into the same integrated circuit.

The light source LS comprises a light emitter such as a surface emitting laser, such as the vertical-cavity surface-emitting laser, or VCSEL. The light emitter has one or more characteristic emission wavelengths. For example, an emission wavelength of the light emitter lies in the near infrared, NIR, e.g., larger than 800 nm and smaller than 10.000 nm. LIDAR applications may rely on the range of emission wavelength of the light emitter is in between 840 nm and 1610 nm, which results in robust emission and detection. This range can be offered by the VCSEL.

The detector array DA comprises one or more photodetectors or pixels. The array of pixels forms an imaging sensor. The pixels are polarization sensitive. Adjacent pixels of the imaging sensor are polarization sensitive each having an orthogonal state of polarization arranged in a checker-board pattern. This will be discussed in more detail below.

The imaging system comprises a modulating circuit (not shown) which is arranged to modulate the intensity of emission by means of the light emitter. In case of a laser, such as the VCSEL, the modulating circuit can be implemented as a laser driver circuit. The modulating circuit may also be integrated in the common integrated circuit arranged in the sensor package. In another embodiment, the laser driver may be located externally with a synchronization in between the laser driver and the sensor ASIC comprising the detector array.

The synchronization circuit SC is arranged in the same sensor package, and, may be integrated in the common integrated circuit. The synchronization circuit is arranged to synchronize emission of light, e.g., constant pulses and modulated light pulses, by means of the light emitter and/or detection by means of the detector array, e.g., as frames A and B.

FIG. 2 shows an example embodiment of a detector array with polarization function. The detector array DA, or imaging sensor, comprises pixels, which are arranged in a pixel map as shown. The imaging sensor can be characterized in that adjacent pixels have different states of polarization. The drawings shows a detector array with on-chip polarizers associated with the pixels, respectively. Such a structure may be integrated using CMOS technology. Adjacent pixels have orthogonal polarization functions, e.g., pixels PxH with horizontal polarization and pixels PxV with vertical polarization. Embodiments of said detector array are disclosed in in EP 3261130 A1, which is hereby incorporated by reference.

FIG. 3 shows a cross section of an example detector array with a high-contrast grating polarizer. This example corresponds to FIG. 1 of EP 3261130 A1 and is cited here for easy reference. The remaining embodiments of detector arrays in EP 3261130 A1 are not excluded but rather incorporated by reference.

The photodetector device, detector array, shown in FIG. 3 comprises a substrate 1 of semiconductor material, which may be silicon, for instance. The photodetectors, or pixels, of the array are suitable for detecting electromagnetic radiation, especially light within a specified range of wavelengths, such as NIR, and are arranged in the substrate 1, e.g., in the common integrated circuit. The detector array may comprise any conventional photodetector structure and is therefore only schematically represented in FIG. 3 by a sensor region 2 in the substrate 1. The sensor region 2 may extend continuously as a layer of the substrate 1, or it may be divided into sections according to a photodetector array.

The substrate 1 may be doped for electric conductivity at least in a region adjacent to the sensor region 2, and the sensor region 2 may be doped, either entirely or in separate sections, for the opposite type of electric conductivity. If the substrate 1 has p-type conductivity the sensor region 2 has n-type conductivity, and vice versa. Thus, a pn-junction 8 or a plurality of pn-junctions 8 is formed at the boundary of the sensor region 2 and can be operated as a photodiode or array of photodiodes by applying a suitable voltage. This is only an example, and the photodetector array may comprise different structures.

A contact region 10 or a plurality of contact regions 10 comprising an electric conductivity that is higher than the conductivity of the adjacent semiconductor material may be provided in the substrate 1 outside the sensor region 2, especially by a higher doping concentration. A further contact region 20 or a plurality of further contact regions 20 comprising an electric conductivity that is higher than the conductivity of the sensor region 2 may be arranged in the substrate 1 contiguous to the sensor region 2 or a section of the sensor region 2. An electric contact 11 can be applied on each contact region 10 and a further electric contact 21 can be applied on each further contact region 20 for external electric connections.

An isolation region 3 may be formed above the sensor region 2. The isolation region 3 is transparent or at least partially transparent to the electromagnetic radiation that is to be detected and has a refractive index for the relevant wavelengths of interest. The isolation region 3 comprises a dielectric material like a field oxide, for instance. If the semiconductor material is silicon, the field oxide can be produced at the surface of the substrate 1 by local oxidation of silicon (LOCOS). As the volume of the material increases during oxidation, the field oxide protrudes from the plane of the substrate surface as shown in FIG. 3.

Grid elements 4 are arranged at a distance d from one another on the surface 13 of the isolation region 3 above the sensor region 2. For example, the grid elements 4 can be arranged immediately on the surface 13 of the isolation region 3. The grid elements 4 may have the same width w, and the distance d may be the same between any two adjacent grid elements 4. The sum of the width w and the distance d is the pitch p, which is a minimal period of the regular lattice formed by the grid elements 4. The length l of the grid elements 4, which is perpendicular to their width w, is indicated in FIG. 3 for one of the grid elements 4 in a perspective view showing the hidden contours by broken lines.

The grid elements 4 are transparent or at least partially transparent to the electromagnetic radiation that is to be detected and have a refractive index for the relevant wavelengths. The grid elements 4 may comprise polysilicon, silicon nitride or niobium pentoxide, for instance. The use of polysilicon for the grid elements 4 has the advantage that the grid elements 4 can be formed in a CMOS process together with the formation of polysilicon electrodes or the like.

The refractive index of the isolation region 3 is lower than the refractive index of the grid elements 4. The isolation region 3 is an example of the region of lower refractive index recited in the claims.

The grid elements 4 are covered by a further region of lower refractive index. In the photodetector device according to FIG. 3, the grid elements 4 are covered by a dielectric layer 5 comprising a refractive index that is lower than the refractive index of the grid elements 4. The dielectric layer 5 may especially comprise borophosphosilicate glass (BPSG), for instance, or silicon dioxide, which is employed in a CMOS process to form intermetal dielectric layers of the wiring. The grid elements 4 are thus embedded in material of lower refractive index and form a high-contrast grating polarizer.

An antireflective coating 7 may be applied on the grid elements 4. It may be formed by removing the dielectric layer 5 above the grid elements 4, depositing a material that is suitable for the antireflective coating 7, and filling the openings with the dielectric material of the dielectric layer 5. The antireflective coating 7 may especially be provided to match the phase of the incident radiation to its propagation constant in the substrate 1. For example, if the substrate 1 comprises silicon, the refractive index of the antireflective coating 7 may be at least approximately the square root of the refractive index of silicon. Silicon nitride may be used for the antireflective coating 7, for instance.

The array of grid elements 4 forms a high-contrast grating, which is comparable to a resonator comprising a high quality-factor. For the vector component of the electric field vector that is parallel to the longitudinal extension of the grid elements 4, i.e., perpendicular to the plane of the cross sections shown in FIG. 3, the high-contrast grating constitutes a reflector. Owing to the difference between the refractive indices, the optical path length of an incident electromagnetic wave is different in the grid elements 4 and in the sections of the further region of lower refractive index 5, 15 located between the grid elements 4. Hence an incident electromagnetic wave reaches the surface 13, 16 of the region of lower refractive index 3, 6, which forms the base of the high-contrast grating, with a phase shift between the portions that have passed a grid element 4 and the portions that have propagated between the grid elements 4. The high-contrast grating can be designed to make the phase shift n or 180° for a specified wavelength, so that the portions in question cancel each other. The high-contrast grating thus constitutes a reflector for a specified wavelength and polarization.

When the vector component of the electric field vector is transverse to the longitudinal extension of the grid elements 4, the electromagnetic wave passes the grid elements 4 essentially undisturbed and is absorbed within the substrate 1 underneath. Thus electron-hole pairs are generated in the semiconductor material. The charge carriers generated by the incident radiation produce an electric current, by which the radiation is detected. Optionally, a voltage is applied to the pn-junction 8 in the reverse direction.

The grid elements 4 may comprise a constant width w, and the distance d between adjacent grid elements 4 may also be constant, so that the high-contrast grating forms a regular lattice. The pitch p of such a grating, which defines a shortest period of the lattice, is the sum of the width w of one grid element 4 and the distance d. For the application of the array of grid elements 4 as a high-contrast grating polarizer, the pitch p is typically smaller than the wavelength of the electromagnetic radiation in the material of the region of lower refractive index n_{low1} and/or in the further region of lower refractive index n_{low2} or even smaller than the wavelength in the grid elements 4. In the region of lower refractive index n_{low1} the wavelength λ₀ in vacuum of the electromagnetic radiation to be detected becomes λ₁=λ₀/n_{low1}. In the further region of lower refractive index n_{low2} the wavelength becomes λ₂=λ₀/n_{low2}. If n_{high} is the refractive index of the grid elements 4, the wavelength λ₀ becomes λ₃=λ₀/n_{high} in the grid elements 4, λ₃<λ₀/n_{low1}, λ₃<λ₀/n_{low2} This dimension denotes a difference between the high-contrast grating used as a polarizer in the photodetector device described above and a conventional diffraction grating.

The pitch p may be larger than a quarter wavelength of the electromagnetic radiation in the grid elements 4. If the wavelength of the electromagnetic radiation to be detected is λ₀ in vacuum, p>λ₃/4=λ₀/(4n_{high}). This distinguishes the high-contrast grating used as a polarizer in the detector array described above from deep-subwavelength gratings. The length l of the grid elements 4 is optionally larger than the wavelength λ₃=λ₀/n_{high} of the electromagnetic radiation in the grid elements 4.

Therefore, the high-contrast grating based polarizer alleviates drawbacks of tight fabrication tolerance and layer thickness control as for diffraction gratings; and the necessity of very small structures and thus very advanced lithograph as for deep sub-wavelength gratings. The detector array with high-contrast grating polarizer can be used for a broad range of applications. Further advantages include an improved extinction coefficient for states of polarization that are to be excluded and an enhanced responsivity for the desired state of polarization.

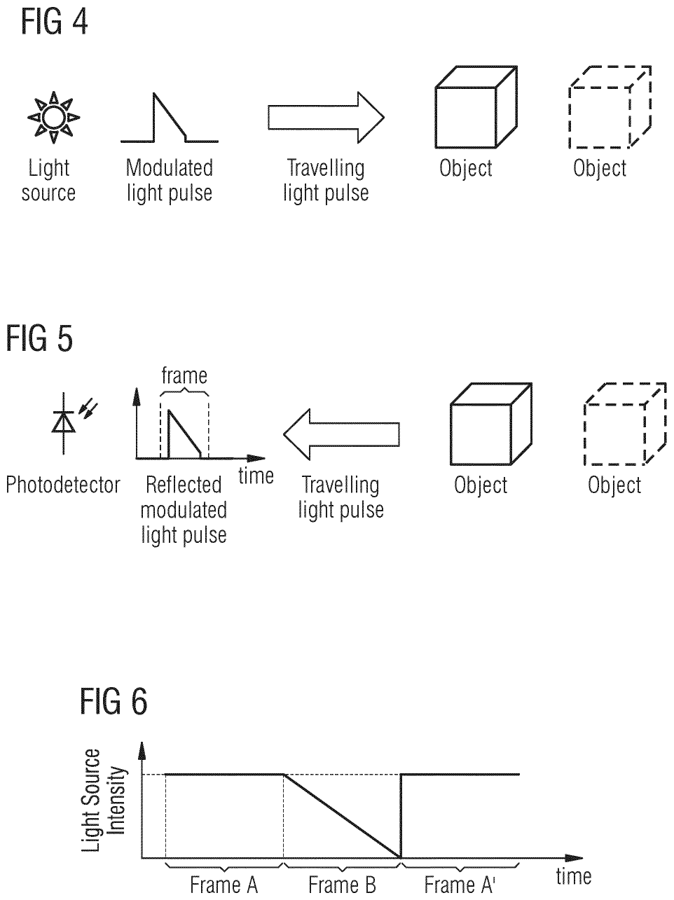

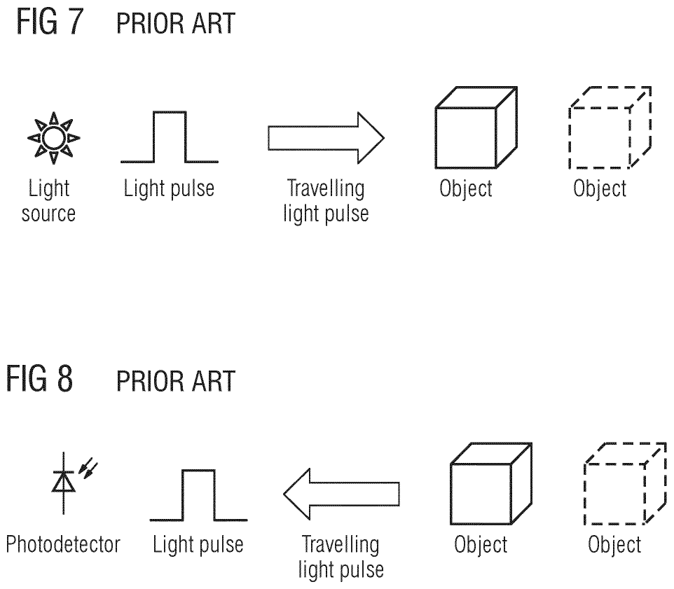

FIG. 4 shows an example embodiment of a detection method, e.g. a LIDAR detection method. The light source, e.g., the VCSEL laser, is modulated such that it emits a modulated light pulse. The modulation circuit is operable as a laser driver circuit, i.e., the circuit drives emission of light by means of the VCSEL, for example. Emission of light is pulsed and the pulses are modulated in intensity, i.e., at least some pulses have an intensity profile, which is monotonously increasing or monotonously decreasing as a function of time. The modulated light pulse in the drawing is characterized in that it starts at high intensity. However, the modulation circuit can also drive the VCSEL to emit light pulses with constant irradiance, i.e., a constant intensity profile. After being emitted either light pulse travels until it is reflected or scattered at one or more objects of the scenery.

The reflected or scattered light returns to the imaging system where the detector array eventually detects the returning light. The backward travelling path is shown in FIG. 5.

FIG. 5 shows an example embodiment of a detection method, e.g., a LIDAR detection method. The light pulse travels until it is reflected or scattered at one or more objects of the scenery. The reflected or scattered light returns to the imaging system where the detector array eventually detects the returning light. The light pulse keeps its modulation so that the detector array detects a modulated intensity as a function of distance.

The imaging system, or LiDAR system, due to its arrangement in a compact sensor package, which may also include dedicated optics, and allows for observing a complete field of view (FOV) at once, called a Flash system. Such a Flash system typically works well for short to mid-range (0-100 m); and by capturing a complete scene at once also several objects and objects with high relative speeds can be detected properly. The synchronization circuit controls a delay between emission of light and a time frame for detection, e.g., the delay between emission of the pulses and a time frame for detection. The delay between an end of the pulse and a beginning of detection may be set, e.g., depending on a distance or distance range to be detected.

The detection may involve this example sequence of operation:
1) Emission of a light pulse with constant irradiance,
2) Acquisition of the “constant image”, e.g., as first image during a first frame,
3) Emission of a modulated light pulse,
4) Acquisition of the “modulated image”, e.g., as second image during a second frame,
5) Calculation of the LIDAR image by division of “modulated image” by “constant image”.

FIG. 6 below shows the timing diagram of the light source. In a first frame A, the light source is operating at a certain level such to illuminate the scene without temporal modulation. The purpose is to acquire a steady-state or dc image. Such image may be grayscale or color depending on the application. In a second frame, frame B, the intensity of the light source is modulated, for example monotonically, e.g., linearly reduced such that items being further away in the scene receive a higher intensity. Close objects receive less intensity.

Of course, also modulation may proceed in the other direction, but it may be more amenable to work with a higher intensity for objects that a further away to account for the natural reduction of the optical signal strength.

Emission of pulses and modulated pulses and/or detection by means of the detector (as frames A and B, for example) is synchronized by means of a synchronization circuit. In fact, light emitter, detector array and synchronization circuit may all be arranged in a same sensor package, wherein at least the detector array and synchronization circuit are integrated in the same integrated circuit. Further components such as a microprocessor to execute the detection method and ADCs, etc. may also be arranged in a same sensor package and integrated into the same integrated circuit.

It should be noted that the examples above are by far non-exhaustive and for a person skilled in the art also similar embodiments could be envisioned. Instead of having monolithically integrated polarizers, the imaging sensor may also have polarizers made from a plastic film. Instead of the proposed single-die approach also several imaging sensors may be employed. Moreover, also a system without polarizers may be contemplated. Possible applications include automotive such as autonomous driving, collision prevention, security and surveillance, industry and automation and consumer electronics.

1. An imaging system comprising:
a light emitter arranged to emit light of modulated intensity, wherein the intensity is modulated monotonously during the acquisition of a frame,
a detector array, and
a synchronization circuit to synchronize the acquisition with the light emitter.

2. The imaging system according to claim 1, wherein
at least the detector array and the synchronization circuit are integrated into a same chip and/or
the imaging comprises a sensor package, which encloses the detector array and the synchronization circuit integrated into the same chip as well as the light emitter.

3. The imaging system according to claim 1, further comprising:
a modulating circuit arranged to drive emission of light by means of the light emitter, and/or
emission of light is pulsed such that, due to modulation, at least some pulses have an intensity profile which is monotonously increasing or monotonously decreasing as a function of time.

4. The imaging system according to claim 1, wherein the synchronization circuit is operable to control a delay between emission of light and a time frame for detection.

5. The imaging system according to claim 4, wherein the emission of light is pulsed and the synchronization circuit sets a delay between an end of a pulse and a beginning of a time frame for detection, respectively.

6. The imaging system according to claim 1, wherein the detector array comprises pixels, which have a polarizing function.

7. The imaging system according to claim 1, wherein adjacent pixels have orthogonal polarization functions.

8. The imaging system according to claim 1, wherein
the detector array comprises units of four pixels, and
a unit has four different polarization functions, respectively.

9. The imaging system according to claim 1, wherein
the emission wavelength of the light emitter is larger than 800 nm and smaller than 10.000 nm, and/or
the emission wavelength of the light emitter is in between 840 nm and 1610 nm.

10. The imaging system according to claim 1, wherein the light emitter comprises at least one semiconductor laser diode such as a surface emitting laser, vertical-cavity surface-emitting laser, VCSEL, or edge emitter laser.

11. The imaging system according to claim 3, further comprising a processing unit which is arranged to:
control the light emitter via the modulating circuit to emit a first, unmodulated light pulse in order to acquire a first image using the detector array,
control the light emitter via the modulating circuit to emit a second, modulated light pulse in order to acquire a second image using the detector array, and the processing unit is further arranged to
process the first and second image to calculate a LIDAR image inferred from a ratio of the second image to the first image and to determine a distance of objects in the LIDAR image.

12. A vehicle comprising,
an imaging system according to claim 1, and
board electronics embedded in the vehicle, wherein:
the imaging system is arranged to provide an output signal to the board electronics.

13. A detection method where a scene is illuminated with:
a first, unmodulated light pulse in order to acquire a first image, and
a second, modulated light pulse in order to acquire a second image.

14. The detection method according to claim 13, wherein a distance of objects of the scene is determined depending on the first and second image.

15. The detection method according to claim 14, wherein a LIDAR image is inferred from a ratio of the second image to the first image and distance information of the scene is determined from the LIDAR image.
